(19) United States
(12) Patent Application Publication
(10) Pub. No.: US 2006/0065769 A1
(43) Pub. Date: Mar. 30, 2006

(54) Grinding machine for all kinds of material, e. g. waste or wood

(76) Inventor: Bernard Kock, Moers (DE)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/530,923

(22) PCT Filed: Oct. 9, 2003
(86) PCT No.: PCT/DE03/03375

§ 371 Date: Apr. 8, 2005

(30) Foreign Application Priority Data
Oct. 10, 2002 (DE) 102 47 281.3

(51) Int. Cl. B02C 18/16

(52) U.S. Cl. 241/236

(57) ABSTRACT

The invention relates to a grinding machine for all kinds of material, the machine comprising: a receiving element for the material (5); at least one shaft (2) positioned in the housing (1) and provided with grinding tools (3); rigid cutting tools (4) which are arranged in the housing (1) and against which the grinding tools (3) operate, grinding the material (5) with specifically low forces. To this end, the grinding tools (3) comprise cutting regions (3.1,3.2) within which an inner cutting region (3.1) can take a large amount of material (5) to be ground and grind the same, thus comprising a small lever arm, and an outer cutting region (3.2) can take a smaller amount of material (5) to be ground and grind the same, thus comprising a large lever arm. According to the invention, the rigid cutting tools (4) are provided with teeth (4.2) having profiles (4.3) which cooperate with one of the cutting regions (3.1, 3.2), a first transversal edge (3.4) of the grinding tools (3) being oriented towards a second transversal edge (4.4) of a tooth (4.2) of the rigid cutting tools (4) in such a way that it cuts past the same.

The invention relates to a comminution machine for all kinds of material, for example waste, such as domestic waste and bulky waste, or wood, comprising a receiving element for the material, provided in a housing, at least one driven shaft, on which comminution tools are provided, and rigid cutting tools arranged in the housing as opposing tools for the comminution tools for comminuting the material.

### PRIOR ART

Comminution machines of this type have been disclosed under the designation “Zerreiβer” [shredders].

Following an overall view of the prior art, an apparatus which has the groups of features described below may be assembled for the comminution machine outlined only generically at the start.

According to EP 0 521 081 B1, as is known the comminution tools are formed by U-shaped knives, which are located in a plane at right angles to the axis of rotation for the shafts and which are arranged uniformly along and around two substantially parallel and horizontal shafts, which are driven by a motor which can drive the shafts in opposite directions, and which have a mutual spacing which is somewhat greater than twice the spacing between the radial outer point of a knife and the axis of rotation. The drive apparatuses are provided between the motor and the shafts.

The material is fed to the knives through a shaft arranged above the knives. These knives interact with knives fixed in a stationary manner between the shafts on part of the frame of the apparatus for material comminution when the shafts rotate in opposite directions, which means that the cutting edge of the blades are moved toward one another on the top side of the stationary knives.

For this purpose, as previously known from the earlier prior art, the mutual spacing between the two shafts is a fixed spacing.

The drive devices comprise, likewise in a previously known way, a suitable gearbox for each of the two shafts, a hydraulic motor with adjustable rotational speed for driving each shaft, an adjustable pump for supplying each hydraulic motor and gearbox, by means of which the motor drives the pumps, which are able to reverse the flow through the hydraulic motors in order to rotate each shaft individually forward and backward in accordance with a predetermined sequence.

From the invention according to EP 0 521 081 B1, it is possible to gather that it is important for each knife to comprise two substantially U-shaped blades arranged one behind the other, for the radially outer and front parts of the two blades, seen in the direction of rotation of the cutting movement of the knives, to be constructed as substantially tangentially oriented wedges, for the spacing between the axis of rotation and the wedge of the front blade to be shorter than the spacing between the axis of rotation and the wedge of the following blade, and for the radially outer contour of the following blade to correspond substantially to a segment of a spiral line around the axis of rotation.

For this purpose, in a functional combination, the features of the comminution machine corresponding to EP 0 928 222 B1, which is of the generic type, can be supplemented in order to obtain a functioning unit.

Accordingly, the stationary knives are formed by a previously known cutting table, which is arranged at the bottom of a hopper having at least one set of fixed, parallel lower knives, which are separated from one another by openings through the table.

Furthermore, at least one rotatable shaft of a drive unit is provided in known manner, which shaft is arranged above the cutting table in a direction which extends at right angles to the lower knives.

Finally, as is known, there is a number of disk-like upper knives, which are fixed to the shaft, of which each knife is provided with a number of teeth and which extends partially downward into each of their openings in the table. Each opening is wider than the associated upper knife which, in addition, is arranged close to one of the lower knives in the associated opening.

According to the invention disclosed there, it is important that the lower knife extends in a direction which intersects the axis of the shaft or a region around the latter, in relation to this design it being assumed that, according to DK 169 378, a cutting table whose plane already extends underneath the shaft is already known.

In this case, on each side of the shaft there is arranged a set of a plurality of knives, whose arrangement in relation to one another forms a V or an inverted V.

The respective cutting edges can be designed to be curved or wavy.

By means of the constructional improvement according to EP 0 928 222 B1 of the cutting table divided into knives, in which the plane of the cutting table intersects the axis of the shaft, the intention is for the material to be comminuted with an advantageous cutting angle of about 90°.

A comminution machine for materials, such as organic waste, bulky waste or the like, assembled in this way in accordance with the documented prior art and described above, in spite of a tried and tested function, still exhibits disadvantages, which consist in particular in the fact that
the stability of the comminution tools fitted to the shaft is endangered,
the effectiveness of the comminution process is limited by the stationary knives,
the throughput cannot be increased, because of the action of the shape of the comminution tools on the shaft, in interplay with the stationary knives, forcing material away, and
the power consumption of the machine is relatively high.

### SUMMARY OF THE NUB OF THE INVENTION

The invention is based on the object of providing a comminution machine for all kinds of material, for example waste, such as domestic waste and bulky waste, or wood, in particular organic waste, bulky waste, such as refrigerators, tires, furniture, carpets, mattresses, tree stumps, demolition timber or similar materials, which comprises
a receiving element for material, provided in a housing,
at least one shaft, on which comminution tools are arranged,
rigid cutting tools which are fitted in the housing, whose cutting edges in the extension just to do not intersect the axis of the shaft or a region around the axis, against which rigid cutting tools the comminution tools of the shaft comminute the material put in.

Thus, in interplay between the comminution tools acting in opposite directions of rotation with the rigid cutting tools, the waste is always taken in a differentiated manner, is conveyed and, fixed against the rigid cutting tools, is comminuted with specifically low forces.

On one hand, the comminution machine must be configured for production, operation, maintenance and repair in subassemblies suited for this purpose and, on the other hand, must be capable of control to the conditions of the comminution process.

As a result of the object to be achieved,
the stability of the comminution tools of the shaft is to be increased,
the level of comminution is to be increased by means of constructional changes in the rigid cutting tools,
the throughput of the machine is to be increased,
the power consumption of the machine is to be reduced,
the ability to comminute in particular ductile, non-brittle-fracture materials, such as plastic and plastic film, is to be promoted and
the material present in the receiving area and to be comminuted directly is to be fed completely to the available cutting geometries
   and these objects are to be satisfied as advantages which act in their entirety as compared with the prior art.

According to the invention, this is achieved in that

a) the comminution tools, seen respectively in a direction of rotation of the shaft and in their cross section, have at least two cutting regions, of which at least an inner cutting region is able to take and comminute more material to be comminuted and has a relatively short lever arm for this purpose, and also at least one outer cutting region is able to take and comminute less material to be comminuted and has a relatively long lever arm for this purpose, the cutting contours of both cutting regions forming a circular arc about the axis of the shaft in the direction of the axis of the shaft,

b) the rigid cutting tools have a number of teeth arranged in a manner of a saw and thus two flanks of the teeth at an angle to each other interact with one of the cutting regions,

c) in each starting effective cutting position, a tip of the comminution tools, forming a first transverse cutter, is oriented toward a tip of a tooth of the rigid cutting tools, forming a second transverse cutter, so as to be offset in parallel and cutting past, as a result of which the, besides the cutting forces produced between the cutting regions of the comminution tools and the cutting edges of the rigid cutting tools, an additional breaking edge, also arranged parallel to the axis of the shaft, with a parallel offset notching action on the material and acting specifically highly is obtained, and

d) the material is subjected to an active and additional comminution process with the aggressive participation of the teeth of the rigid cutting tools.

In a further development of the invention, the comminution tools are offset in relation to one another in the axial direction on the shaft or are arranged with a different radial spacing, the teeth on the rigid cutting tools also being arranged accordingly, which cutting tools run as a slab, as it is known.

Furthermore, the shaft has disks on which the comminution tools are arranged or formed. These comminution tools interact with the teeth, specifically intermeshing between the rigid cutting tools of the slab arranged at intervals.

In order to be able to install and dismantle the shaft in a beneficial way, it has journals on both sides which are detachably connected to the shaft and, if appropriate, form a bearing region. In this case, the joint can be configured such that it is made by means of a flange.

The housing is of double-walled design at the ends and, in between these, a disk connected to the shaft and sealing in the manner of a labyrinth against the emergence of material is provided, which can expediently be formed by the flange.

The cutting contours of the teeth of the rigid cutting tools configured in the manner of a saw can be formed by wearing elements which, for example, can be replaceable.

In support of the advantages which result from the actions according to the invention, such as
increasing the level of comminution,
increasing the throughput and
reducing the power consumption
   in order to improve the efficiency of the comminution machine, for the further optimization of the comminution process, use is also made of a controller which obtains its reference variables from at least one gradient of a parameter of the comminution process.

### BRIEF DESCRIPTION OF THE DRAWINGS

The invention will be explained in more detail below using an exemplary embodiment. In the drawings:

FIG. 1 shows a longitudinally sectioned side view of the comminution machine,

FIG. 2 shows a plan view according to FIG. 1,

FIG. 3 shows the cross section corresponding to FIGS. 1 and 2 in a simplified representation of the features important to the invention of the phases of the active principle of the invention between the comminution tools and the rigid cutting tools in the operating phase of the material put in and not yet comminuted,

FIG. 4 shows the cross section analogous to FIG. 3 in the operating phase of the started comminution process, and

FIG. 5 shows the cross section analogous to FIGS. 3 and 4 in the operating phase of the further comminution.

### BEST WAY OF IMPLEMENTING THE INVENTION

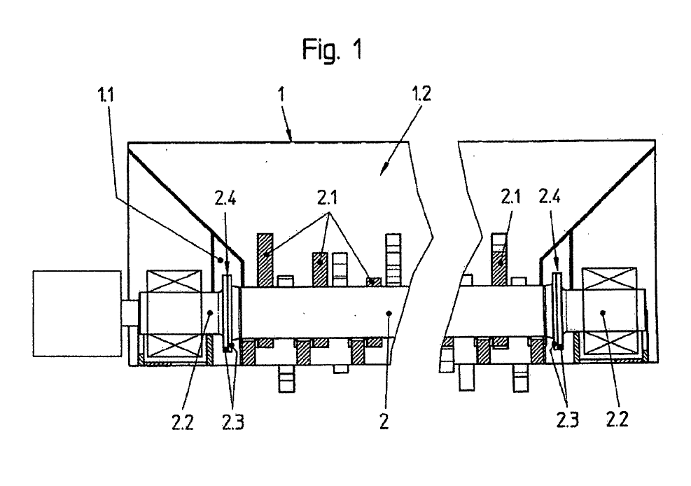

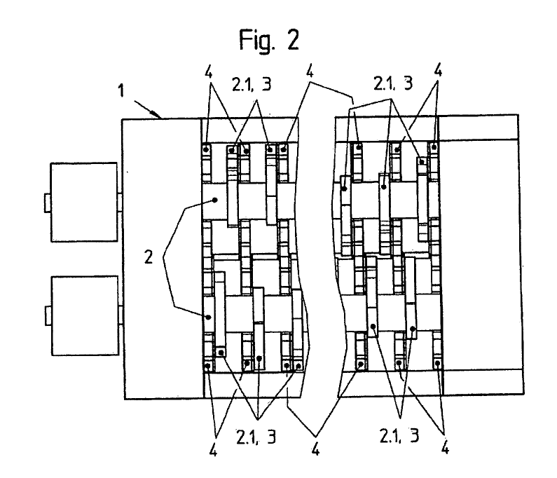

A comminution machine according to the invention for domestic waste, bulky waste or wood, according to FIGS. 1 and 2, comprises a housing 1 having two shafts 2 mounted therein and driven in opposite directions. Arranged on the shafts 2 are disks 2.1 which have comminution tools 3. These comminution tools are lined up in a row at intervals from one another on the shafts 2 such that they operate offset in parallel in interaction with rigid cutting tools 4, which run as a slab in the axial direction of the shafts 2, and comminute material 5 put in via a receiving element 1.2 in a cutting manner.

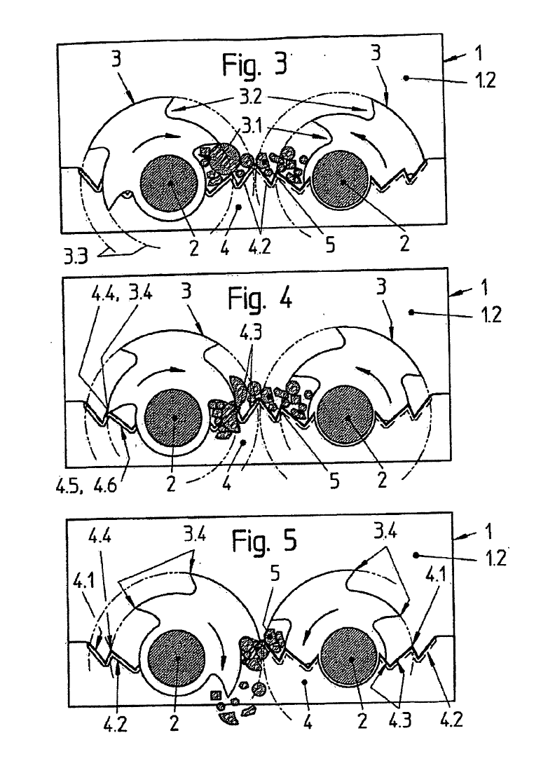

As compared with the known prior art, it is important for the technical requirement on the comminution machine that imaginary extensions of the cutting edges 4.1 (FIGS. 3 to 5) of the rigid cutting tools 4 do not intersect the axis of the shafts 2 or regions around the axis.

This requirement is aimed at the fact that, in interplay of the comminution tools 3 with the rigid cutting tools 4, the material 5 can be taken in a differentiated manner, conveyed and, fixed against the rigid cutting tools 4, comminuted with specifically low forces. This means that the efficiency of the comminution machine with regard to the comminution process is increased substantially as compared with the conventional shredders.

In accordance with FIGS. 3 to 5, the comminution tools 3, in each case seen in a direction of rotation of the shaft 2 and in their cross section, have two cutting regions 3.1, 3.2 which are configured such that the stability of the comminution tools 3 is not endangered.

An inner cutting region 3.1 takes more material 5 to be comminuted and acts with a relatively short lever arm, and an outer cutting region 3.2 takes less material 5 to be comminuted and acts with a relatively long lever arm. In this case, the contours 3.3 of said cutting region 3.1, 3.2 in each case describe a concentric circular arc about the shaft 2 in the direction of the axes of the shafts 2.

Basically, with this design implementation, the preconditions are given for using the available forces more effectively than hitherto for the comminution process of the respective material and in a more differentiated manner.

In a functional correspondence with this, the rigid cutting tools 4 have a plurality of teeth 4.2 arranged in the manner of a saw. Thus, two flanks 4.3 of the teeth 4.2 at an angle to each other interact with at least one of the cutting regions 3.1, 3.2 in such a way that the respective material 5 is always clamped in and is notched and cut comprehensively by the available edges of the cutters.

Added to this, and fusing functionally with this effect, is the fact that in each starting cutting position becoming effective a tip of the comminution tools 3, forming a respective first transverse cutter 3.4, is oriented toward a tip of a tooth 4.2 of the rigid cutting tools 4, forming a respective second transverse cutter 4.4, so as to be offset in parallel and cutting past. As a result, besides the cutting forces produced and acting between the cutting regions 3.1 and 3.2 of the comminution tools 3 and the cutting edges 4.1 of the rigid cutting tools 4, an additional breaking edge, also arranged parallel to the axis of the shaft 2, with a notching action offset parallel to the respective piece of material 5 and acting specifically highly is obtained.

This combination of features thus subjects the material 5 to an active and additional comminution process with the aggressive participation of the teeth 4.2 of the rigid cutting tools 4.

Conclusively in relation to the increased requirements placed and to the object set in accordance with the invention, this comminution machine is better suited to the types of material 5 outlined at the beginning in comminution practice, in that
the stability of the comminution tools 3 is increased,
the level of comminution and the throughput are increased,
the power consumption is reduced
   and, finally, the comminution process of a “shredder” is supported.

The improved actions of the comminution machine according to the invention can be gathered from FIGS. 3 to 5 in three phases illustrated:
According to FIG. 3, the illustration shows schematically how the material 5 can be taken in different volumes by cutting regions 3.1, 3.2 acting with different lever arms and can be distributed to the rigid cutting tools 4 between the two flanks 4.3 in such a way that the comminution is prepared optimally.
With FIG. 4, it becomes clear how, in a functional fusion, firstly of the actions of the cutting regions 3.1, 3.2 against the cutting-edges 4.1, the material 5 clamped in the flanks 4.3 is cut and, secondly, is subjected to the corresponding actions of the first transverse cutters 3.4 with the second transverse cutters 4.4 and the additional breaking edge effect.
Finally, FIG. 5 shows in particular the phase in which the outer cutting regions 3.2 having the long lever arm and the less taken material 5 act against the rigid cutting tools 4.

While maintaining the active principle according to the invention and assisting the matter further, according to FIGS. 1 and 2, the combination tools 3 are arranged offset radially from one another in the actual direction on the shafts 2. Not illustrated in the figures is the possibility that the combination tools 3 are arranged in a different angular position on the shafts 2, that is to say axially in the cutting profile, for example running conically. The teeth 4.2 of the rigid cutting tools 4 running axially as a slab also have to be arranged correspondingly.

The technologically beneficial implementation for the production, the operation, the maintenance and repair of the comminution machine according to the invention is achieved with the features further illustrated in FIG. 1. For this purpose, the shafts 2 have journals 2.2 with a bearing region at the ends. The joint between the journals 2.2 and the shafts 2 is made by means of flanges 2.3.

For operation in practice, in order to assist optimal comminution and reliability of the comminution machine, it is important that no material 5 penetrates through components to be sealed off from one another. Therefore, the housing 1 according to FIG. 1 is designed with a double wall 1.1 at the ends, in which the journals 2.2 or ends of the shaft 2 have a disk seal 2.4, which forms a sealing labyrinth with the double wall 1.1. The disk seal 2.4 is technologically advantageously formed by the flange 2.3.

In order to protect the rigid cutting tools 4 against wear, it is beneficial, as indicated in FIGS. 3 to 5, to equip the cutting contours 4.5 with wearing elements 4.6.

### COMMERCIAL APPLICABILITY

In all of the features claimed, a comminution machine designed according to the invention is optimally able to meet the increased requirements on the comminution of material of the types described, for this purpose means also being provided with which the gradient of a parameter of the comminution machine is registered and used as a reference variable for the control of the comminution machine.

### LIST OF DESIGNATIONS

1=Housing
1.1=Double wall
1.2=Receiving element for material
2=Shaft
2.1=Disk
2.2=Journal
2.3=Flange
2.4=Disk seal
3=Comminution tool
3.1=Inner cutting region, short lever arm
3.2=Outer cutting region, long lever arm
3.3=Contour
3.4=First transverse cutter
4=Rigid cutting tool
4.1=Cutting edge
4.2=Tooth
4.3=Tooth flank
4.4=Second transverse cutter
4.5=Cutting contour
4.6=Wearing element
5=Material

1. A grinding machine, comprising:
a housing having a receiving element which receives material;
at least one shaft which is axially mounted in the housing;
a plurality of grinding tools connected to the at least one shaft in an angular position in an axial direction of the least one shaft, each grinding tool having a first transverse cutter, an inner cutting region and an outer cutting region such that the inner cutting region is configured to receive from the receiving element a first amount of material and the outer cutting region is configured to receive from the receiving element a second amount of material, the inner cutting region having a shorter lever arm than the outer cutting region; and
a plurality of rigid cutting tools arranged within the housing in a fixed position on opposing sides of the least one shaft, each rigid cutting tool having teeth and a second transverse cutter wherein the at least one shaft rotates the plurality of grinding tools such that the inner cutting region grinds the amount of material against the teeth of the rigid cutting tools, the outer cutting region grinds the other amount of material against the teeth of the rigid cutting tools and the first transverse cutter orientates in an offset parallel position toward the second transverse cutter to grind material between the first transverse cutter and the second transverse cutter.

2. The grinding machine of claim 1, wherein the plurality of grinding tools are offset in relation to one another in the angular position in an axial direction of the at least one shaft.

3. The grinding machine of claim 2, wherein the plurality of grinding tools are arranged in a radial spacing with respect to the axis of the at least one shaft.

4. The grinding machine of claim 3, wherein the teeth of the rigid cutting tools extend offset parallel in the axial direction such that the first transverse cutter is oriented toward the second transverse cutters grind the material in an offset parallel action.

5. The grinding machine of claim 1, wherein the at least one shaft has disks on which the grinding tools are arranged; wherein the grinding tools intermesh between the rigid cutting tools and act against the rigid cutting tools in a cutting manner.

6. The grinding machine of claim 1, characterized in that wherein the at least one shaft has journals which are detachably joined to the at least one shaft.

7. The comminution grinding machine of claim 6, wherein the journals form a bearing region.

8. The grinding machine of claim 7, further comprising flanges which form a joint between the journals and the at least one shaft.

9. The grinding machine of claim 8, wherein the housing is formed with a double wall at ends of the housing and, in the interspace therein, a disk seal connected to the at least one shaft is provided to form a seal.

10. The grinding machine of claim 9, wherein the seal is formed by the flanges.

11. The grinding machine of claim 1, wherein the rigid cutting tools are reinforced by wearing elements.

12. The grinding machine of claim 1, further comprising a means for controlling the grinding machine wherein a gradient of a parameter of the grinding process or grinding machine is registered and used as a reference variable for control of the grinding machine.

13. The grinding machine according to claim 1, wherein the plurality of rigid cutting tools are fixed within the housing in a position separate from the axis of the at least one shaft.

14. The grinding machine of claim 1, wherein the inner cutting region and the outer cutting region include contours which form a circular arc about the axis of the at least one shaft in the direction of the axis of the least one shaft.

15. The grinding machine of claim 1, wherein the second amount of material received by the outer cutting region is less than the first amount of material received by the inner cutting region.

16. The grinding machine of claim 1, wherein the plurality of grinding tools are circumferentially connected to the at least one shaft.
